(19) United States
(12) Patent Application Publication
(10) Pub. No.: US 2010/0046903 A1
(43) Pub. Date: Feb. 25, 2010

(54) STRUCTURE OF OPTIC FILM

(76) Inventors: Chien-Chin MAI, Kaohsiung City (TW); Jui-Tang YIN, Kaohsiung City (TW); Yeong-Feng Wang, Kaohsiung City (TW)

Correspondence Address: LEONG C LEI, PMB # 1008, 1867 YGNACIO VALLEY ROAD, WALNUT CREEK, CA, 94598, US

(21) Appl. No.: 12/193,770

(22) Filed: Aug. 19, 2008

(51) Int. Cl. G02B 6/10

(52) U.S. Cl. 385/132

(57) ABSTRACT

An optic film has a surface on which a plurality of rib-like micro light guides is formed. Each micro light guide includes a plurality of ridges, which are of different heights and show variation of height. Either a high ridge or a low ridge of the micro light guide is made a continuous left-and-right wavy configuration and/or a continuous up-and-down height-variation configuration. The high ridge has a top that is rounded, whereby by means of the rounded top of the high ridge, the high ridge of the optic film is protected from abrasion and wear or is prevented from causing damage to other parts of an optic device. Thus, protection of the optic film and other parts can be realized.

### BACKGROUND OF THE INVENTION

(a) Technical Field of the Invention

The present invention relates to an optic film, and in particular to a structure of optic film that prevents the optic film from abrasion and wear.

(b) Description of the Prior Art

A thin-film transistor liquid crystal display (TFT-LCD) comprises a light source that is provided by a backlight module. The backlight module must provide light of excellent uniformity and brightness in order to ensure excellent subsequent application and use.

As shown in FIG. 1 of the attached drawings, a conventional backlight module 1 comprises at least a light guide board 11, a reflector film 12, a number of optic films 13, and a light source 14.

The light guide board 11 has at least one light incidence surface 111, a reflection surface 112, and a light emitting surface 113. The light incidence surface 111 receives light from the light source 14 to allow the light to transmit into the interior of the light guide board 11. The reflection surface 112 serves to change the direction of traveling of the light, and the reflection surface 112 is provided with a plurality of light guide spots 1121, which are used to break total reflection of light on the reflection surface 112 so as to make the light uniform when reflected. The light emitting surface 113 serves to give off the light from the light guide board 11.

The reflector film 12 is laid flat outside the reflection surface 112 of the light guide board 11 to reflect light traveling outside the light guide board 11 back into the light guide board 11.

The optic films 13 are arranged outside the light emitting surface 113 of the light guide board 11. The optic films 13 may include a diffusion film 131 that diffuse the light and a prism film 132 that effects convergence of the light. The number and sequence of arrangement of the optic films 13 can be varied as desired. The prism film 132 has a surface on which a plurality of minute prisms 1321 is formed and the prisms 1321 are arrangement linearly on the surface of the prism film 132. Further, the prisms 1321 of two adjacent prism films 132 are extended in perpendicular directions so as to effect all-direction light convergence.

The light source 14 supplies light to the light guide board 11 and is arranged outside the light incidence surface 111. Based on the requirement of different specification of merchandises using backlight modules, the light source 14 can be of different numbers.

In the above described backlight module 1, two prism films 132 are required to satisfy the need of a liquid crystal display. However, since prisms 1321 formed on the surface of the prism film 132 have an apex that forms a sharp tip, when the prism films 132 are stacked over each other, the sharp apexes of the prisms 1321 are subject to damage caused by abrasion and wear or the prisms 1321 damage an optic film 13 placed thereon, both resulting in deterioration of performance of the backlight module 1.

In view of the above discussed drawbacks of the prisms 1321 of the conventional prism film 132, the present invention is aimed to provide a structure of an optic film that overcomes the drawbacks.

### SUMMARY OF THE INVENTION

The primary purpose of the present invention is to overcome abrasion and/or wear of the sharp apexes of the prisms occurring when two prism films are stacked over each other, and/or to overcome damage of an optic film placed on the prism film caused by the sharp apexes of the prisms, both leading to deterioration of performance of a backlight module incorporating the prism films.

Thus, an objective of the present invention is to provide an optic film that has a surface on which a plurality of rib-like micro light guides is formed. Each micro light guide comprises a plurality of ridges, which are of different heights and show variation of height. Either a high ridge or a low ridge of the micro light guide is made a continuous left-and-right wavy configuration and/or a continuous up-and-down height-variation configuration. The high ridge has a top that is rounded, whereby by means of the rounded top of the high ridge, the high ridge of the optic film is protected from abrasion and wear or is prevented from causing damage to other parts of an optic device. Thus, protection of the optic film and other parts can be realized.

Another objective of the present invention is to provide an optic film has a surface on which a plurality of rib-like micro light guides is formed. Each micro light guide includes a plurality of ridges, which are of identical height. The ridges of the micro light guide are made, in part or all, a continuous left-and-right wavy configuration and/or a continuous up-and-down height-variation configuration. Each ridge has a top that is rounded, whereby by means of the rounded top of the high ridge, the high ridge of the optic film is protected from abrasion and wear or is prevented from causing damage to other parts of an optic device. Thus, protection of the optic film and other parts can be realized

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows an exploded view of a conventional backlight module;

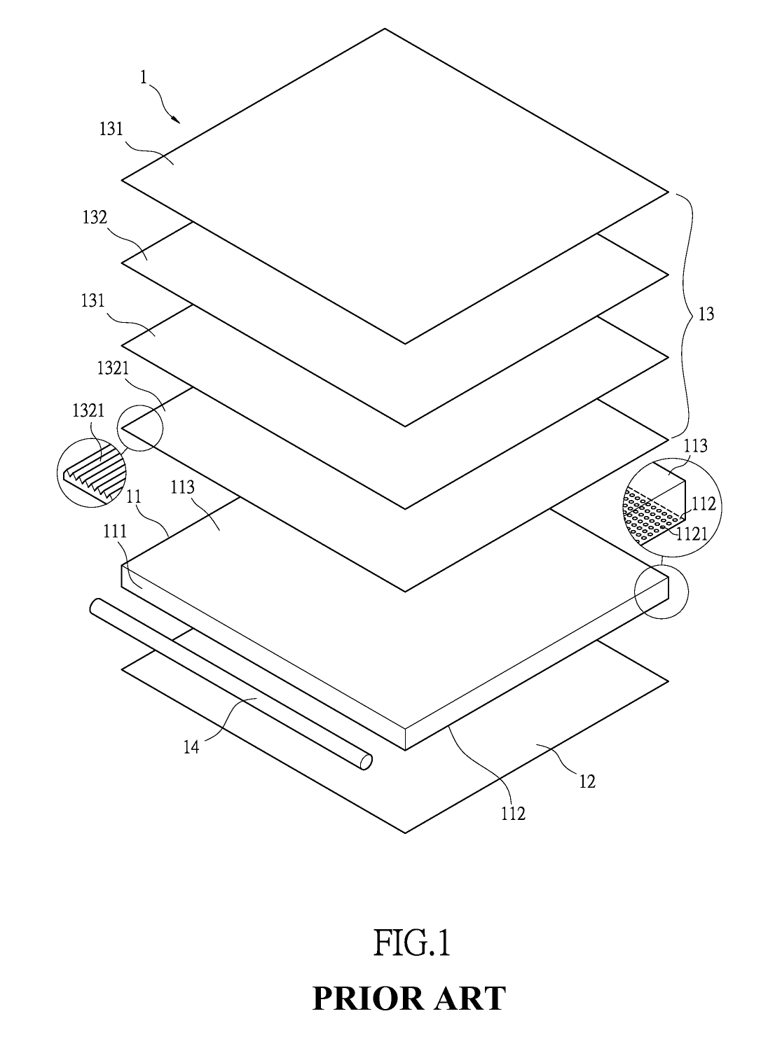

FIG. 2 shows a perspective view of an optic film constructed in accordance with a first embodiment of the present invention;

FIG. 3 shows a top plan view and an end view of the optic film of FIG. 2;

FIG. 4 shows a perspective view of an optic film constructed in accordance with a second embodiment of the present invention;

FIG. 5 shows a top plan view and an end view of the optic film of FIG. 4;

FIG. 6 is a perspective view illustrating both high and low ridges of an optic film in accordance with the present invention having rounded tops;

FIG. 7 shows a perspective view of an optic film constructed in accordance with a third embodiment of the present invention;

FIG. 8 shows a top plan view, an end view, and a side elevational view of the optic film of FIG. 7;

FIG. 9 shows a perspective view of an optic film constructed in accordance with a fourth embodiment of the present invention;

FIG. 10 shows a top plan view, an end view, and a side elevational view of the optic film of FIG. 9;

FIG. 11 shows a perspective view of an optic film constructed in accordance with a fifth embodiment of the present invention;

FIG. 12 shows a top plan view, an end view, and a side elevational view of the optic film of FIG. 11;

FIG. 13 shows a perspective view of an optic film constructed in accordance with a sixth embodiment of the present invention;

FIG. 14 shows a top plan view, an end view, and a side elevational view of the optic film of FIG. 13;

FIG. 15 shows a perspective view of an optic film constructed in accordance with a seventh embodiment of the present invention;

FIG. 16 shows a top plan view, an end view, and a side elevational view of the optic film of FIG. 15;

FIG. 17 shows a perspective view of an optic film constructed in accordance with an eighth embodiment of the present invention;

FIG. 18 shows a top plan view and an end view of the optic film of FIG. 17;

FIG. 19 shows a perspective view of an optic film constructed in accordance with a ninth embodiment of the present invention;

FIG. 20 shows a top plan view and an end view of the optic film of FIG. 19;

FIG. 21 shows a perspective view of an optic film constructed in accordance with a tenth embodiment of the present invention;

FIG. 22 shows a top plan view and an end view of the optic film of FIG. 21;

FIG. 23 shows a perspective view of an optic film constructed in accordance with an eleventh embodiment of the present invention;

FIG. 24 shows a top plan view and a side elevational view of the optic film of FIG. 23;

FIG. 25 shows a perspective view of an optic film constructed in accordance with a twelfth embodiment of the present invention;

FIG. 26 shows a top plan view, an end view, and a side elevational view of the optic film of FIG. 25;

FIG. 27 shows a perspective view of an optic film constructed in accordance with a thirteenth embodiment of the present invention;

FIG. 28 shows a top plan view, an end view, and a side elevational view of the optic film of FIG. 27;

FIG. 29 shows a perspective view of an optic film constructed in accordance with a fourteenth embodiment of the present invention;

FIG. 30 shows a top plan view, an end view, and a side elevational view of the optic film of FIG. 29;

FIG. 31 shows a perspective view of an optic film constructed in accordance with a fifteenth embodiment of the present invention;

FIG. 32 shows a top plan view, an end view, and a side elevational view of the optic film of FIG. 31;

FIG. 33 shows a perspective view of an optic film constructed in accordance with a sixteenth embodiment of the present invention; and

FIG. 34 shows a top plan view, an end view, and a side elevational view of the optic film of FIG. 33.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

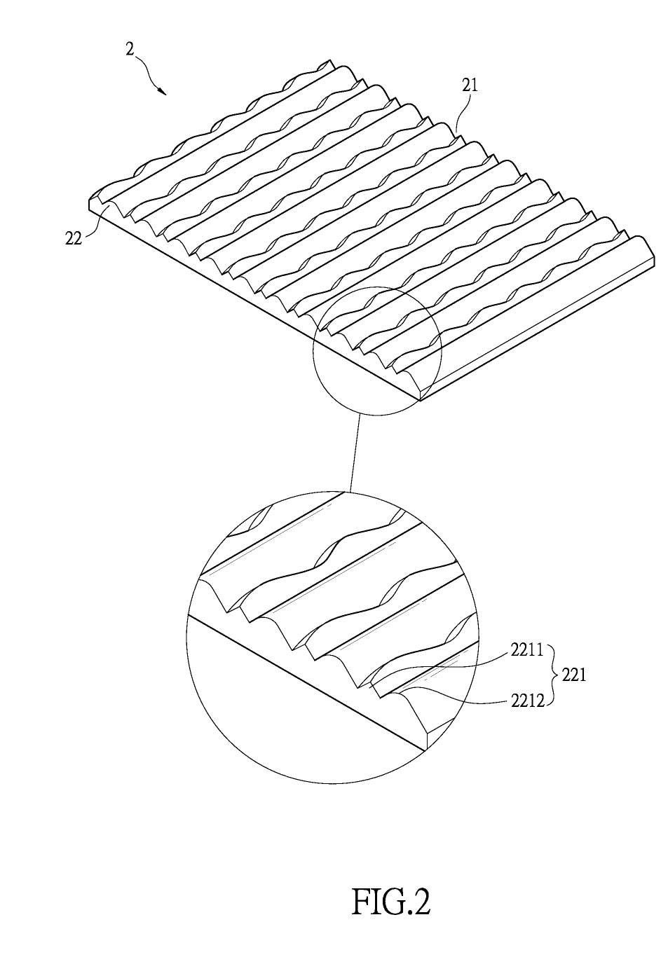

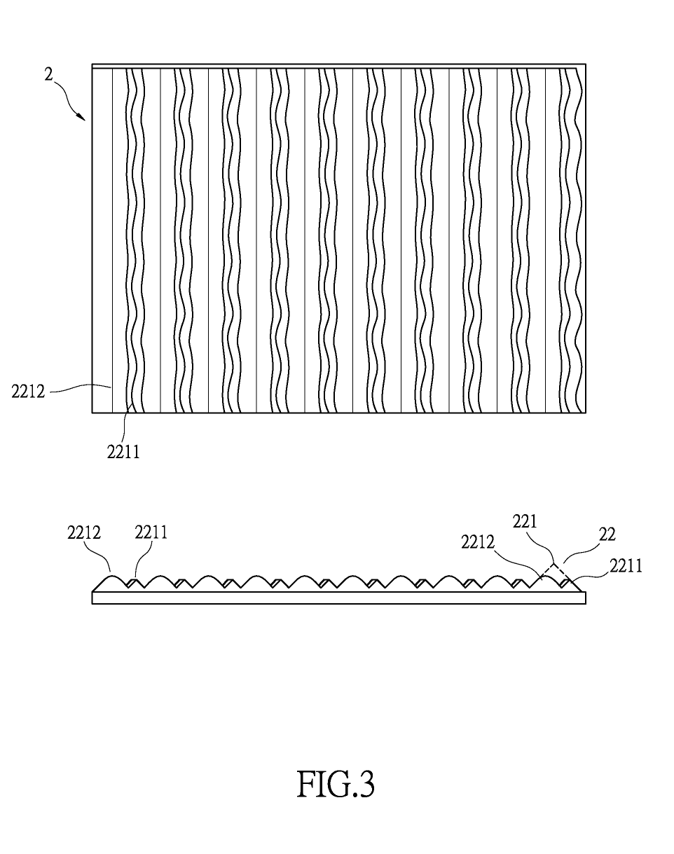

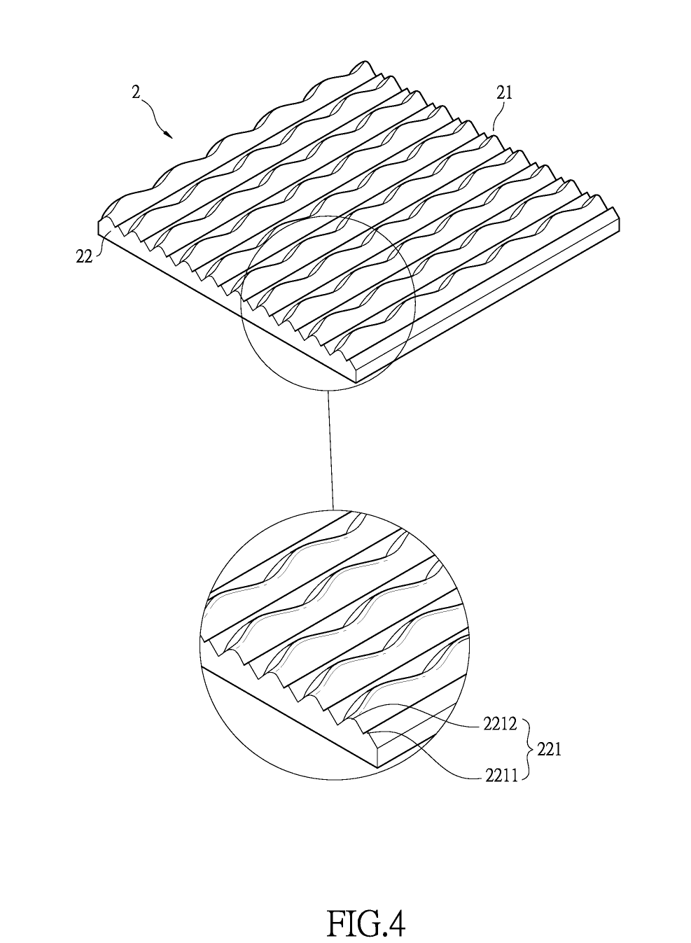

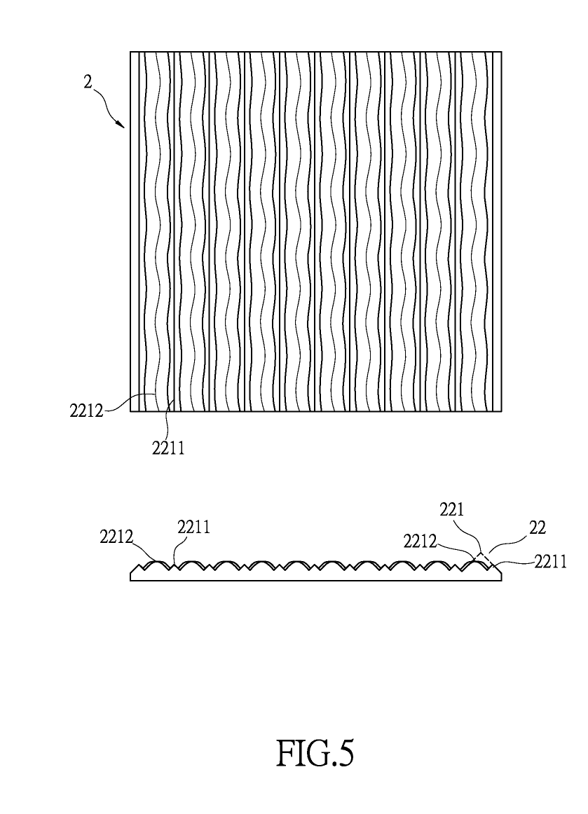

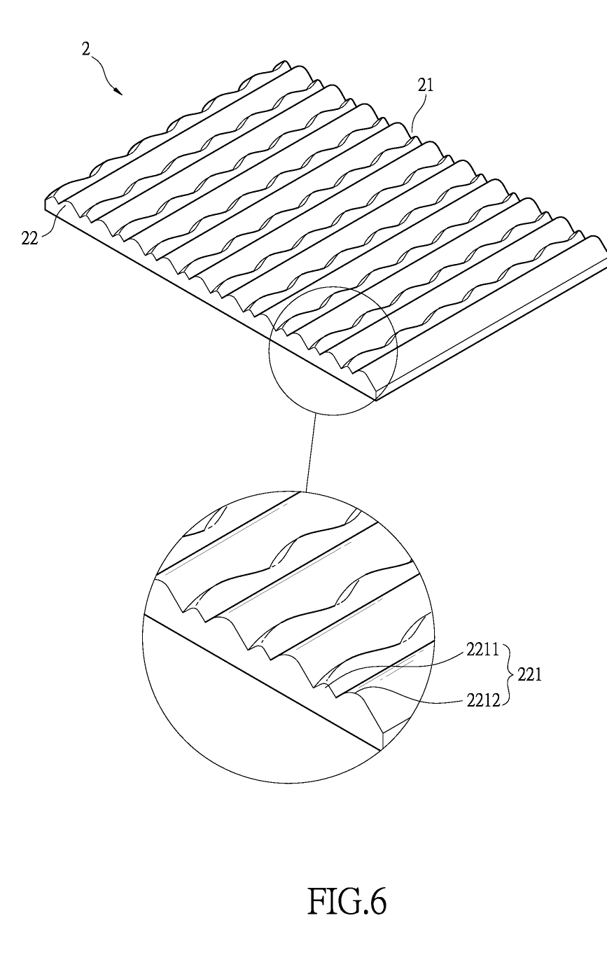

With reference to the drawings and in particular to FIGS. 2-5, an optical film constructed in accordance with the present invention, generally designated with reference numeral 2, is made of a material that has excellent light transmittance. The optic film 7 has a surface 21 on which a plurality of rib-like micro light guides 22 is formed. The rib-like micro light guides 22 can be made of the same material as a body of the optic film 2, or alternatively, the rib-like micro light guides 22 are made of a material or materials different from that making the body of the optic film 2. Each micro light guide 22 comprises at least two ridges 221 and the ridges 221 of the micro light guide 22 are of different heights and thus include a low ridge 2211 and a high ridge 2212. (In the embodiment illustrated, the number of the ridges is taken as two for illustration purposes.) The high ridge 2212 has a top that is of a rounded configuration; and as shown in FIG. 6, the low ridge 2211 has a top, which can also be rounded.

Either the low ridge 2211 or the high ridge 2212 of the micro light guide 22 or both are of a continuous left-and-right wavy configuration. As such, when light transmits through the optic film 2, the continuous left-and-right wavy configuration of the low ridge 2211 (or the high ridge 2212) causes the light that transmits through and is converged by the micro light guide 22 to leave the micro light guide 22 in a non-straight linear form, and each contains variations caused by curving. Thus, the light beam so converged in a regular form, which prevents the light from inducing refraction when the light passes through thin-film transistors and color filters of a liquid crystal display panel whereby no interference pattern will occur in image displaying of the liquid crystal display panel. The rounded configuration of the top of the high ridge 2212 helps protecting the top of the high ridge 2212 or the low ridge 2211 from damage caused by abrasion and/or wear when the optic films are stacked either after they have been assembled or when they are subjected to test, or helps protecting other parts from being damaged by the ridges, whereby the optic film 2 or the other parts can be properly protected and the optic performance thereof can be ensured.

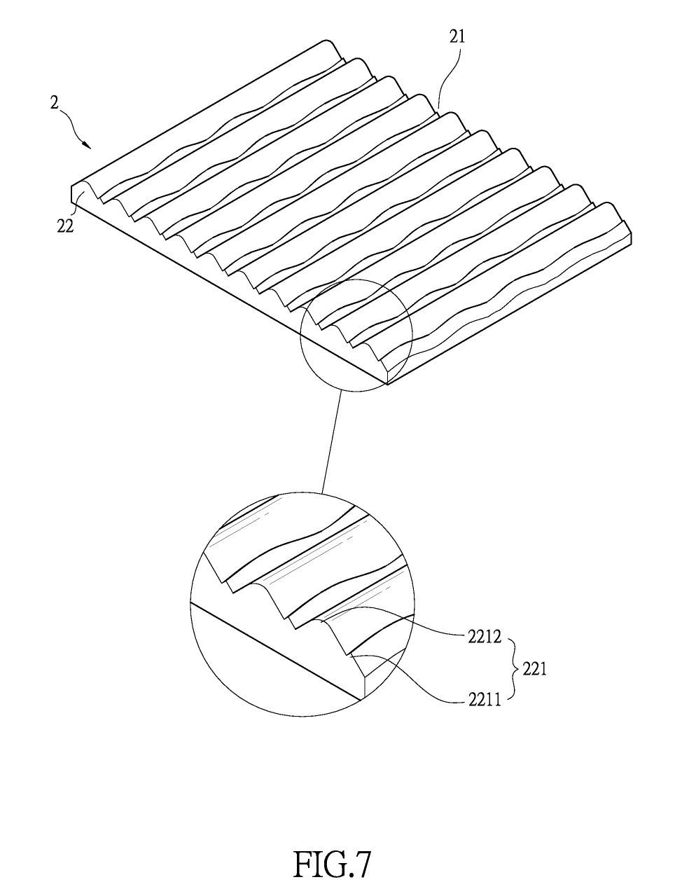

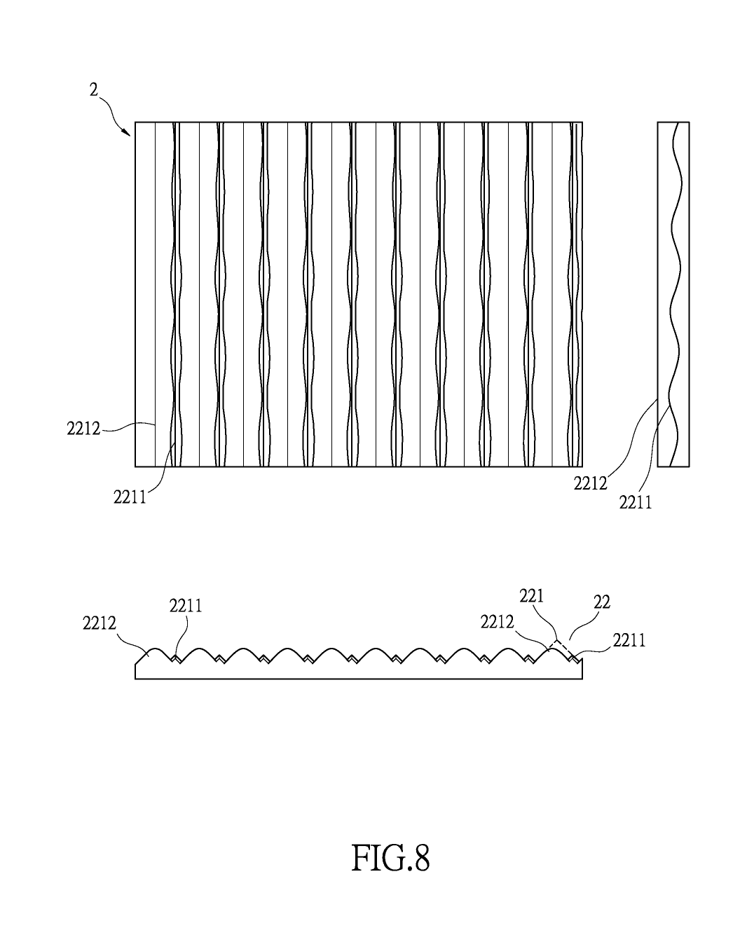

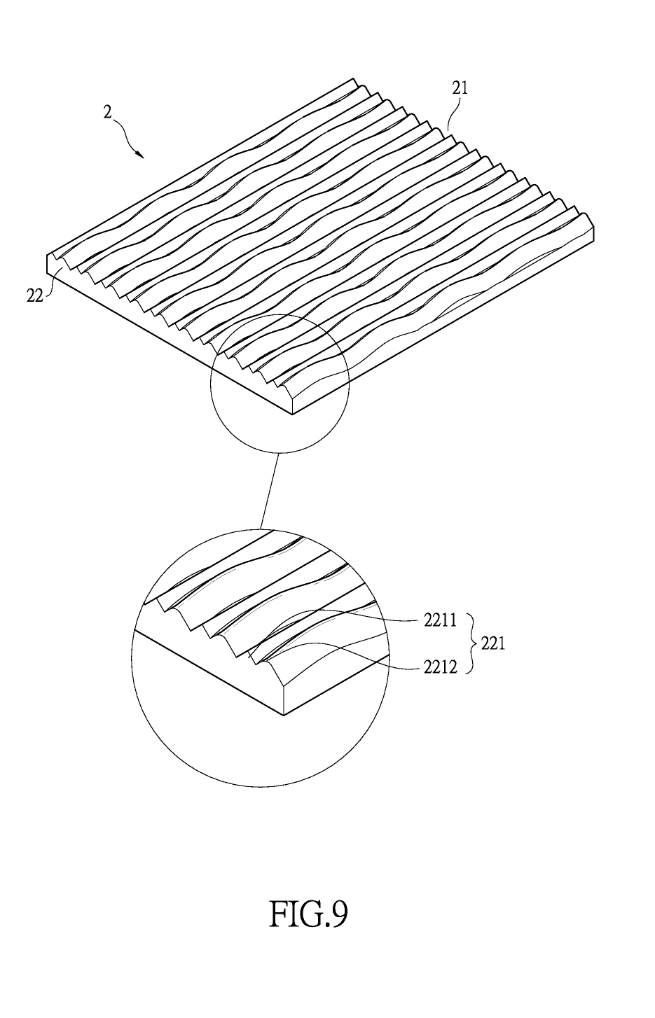

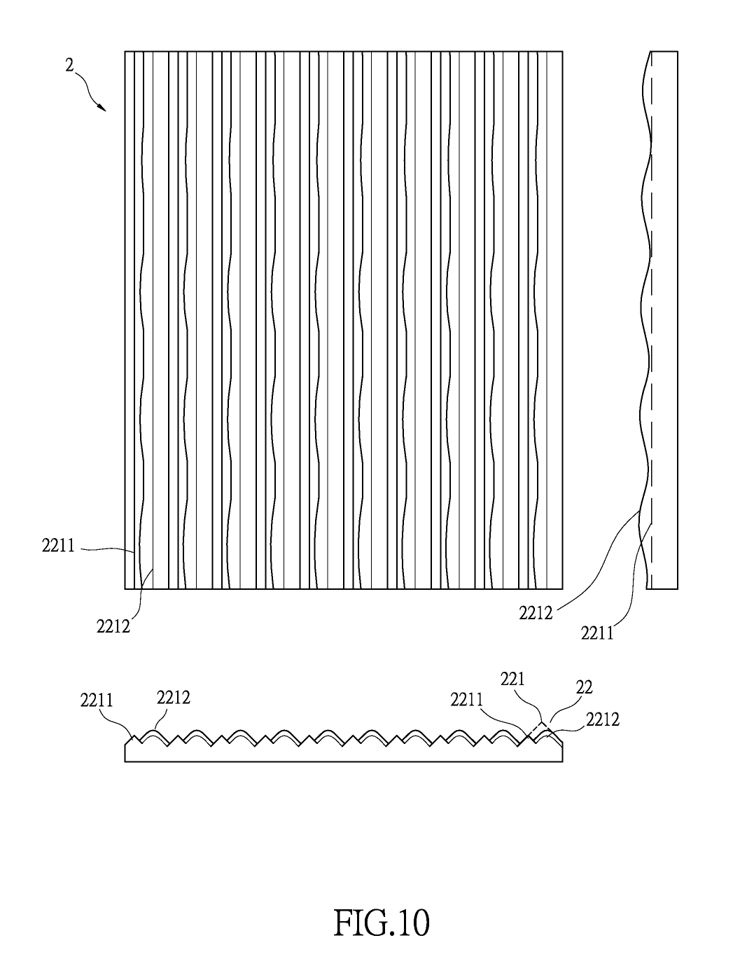

Referring to FIGS. 7-10, in practicing the present invention, the low ridge 2211 or the high ridge 2212 of the micro light guide 22 or both can be alternatively made a continuous up-and-down height-variation configuration. As such, when light transmits through the optic film 2, the continuous up-and-down wavy configuration of the low ridge 2211 (or the high ridge 2212) of the micro light guide 22 can similarly make the light beam that is converged by the optic film 2 irregular so that the light induces no interference pattern in a liquid crystal display panel when the light passes through thin-film transistors and color filters of the liquid crystal display panel. The rounded configuration of the top of the high ridge 2212 helps protecting the top of the high ridge 2212 or the low ridge 2211 from damage caused by abrasion and/or wear when the optic films are stacked either after they have been assembled or when they are subjected to test, or helps protecting other parts from being damaged by the ridges, whereby the optic film 2 or the other parts can be properly protected and the optic performance thereof can be ensured.

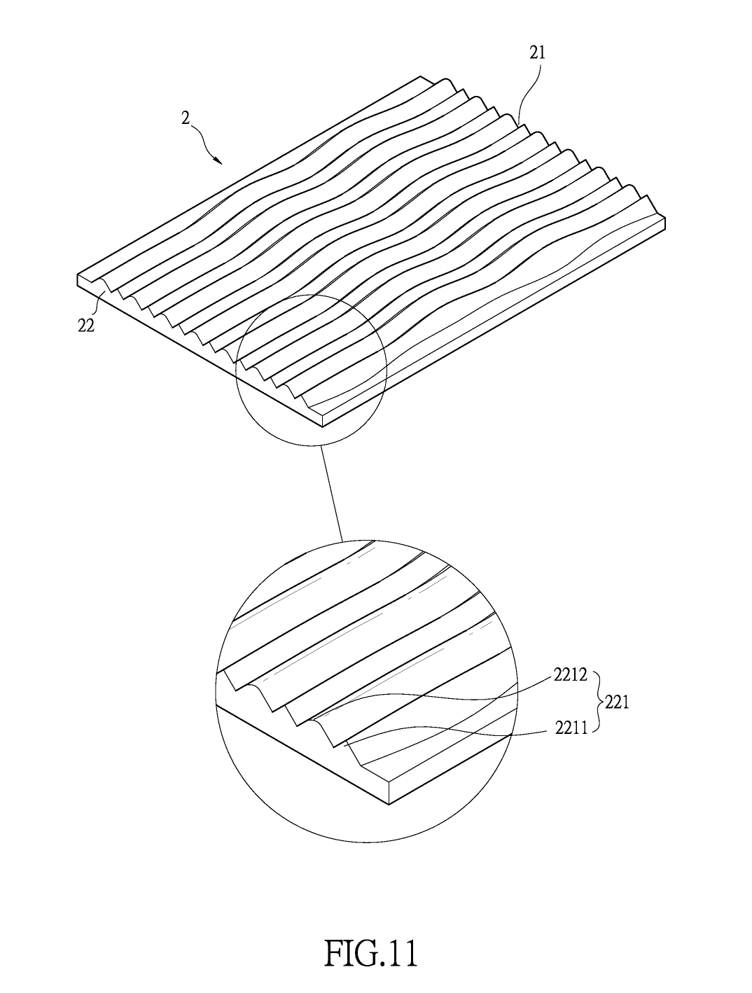

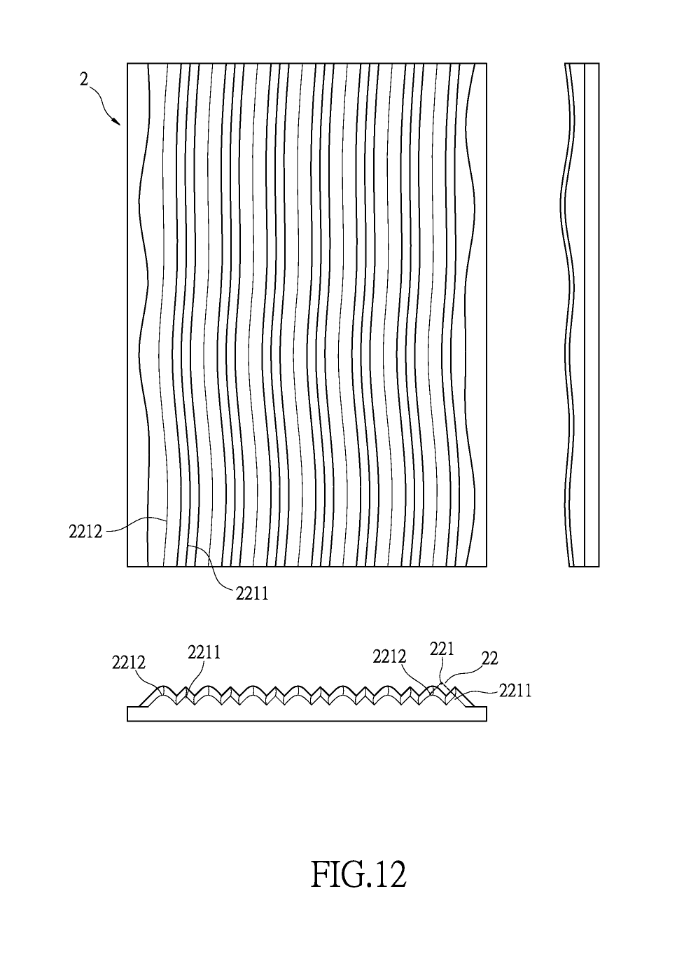

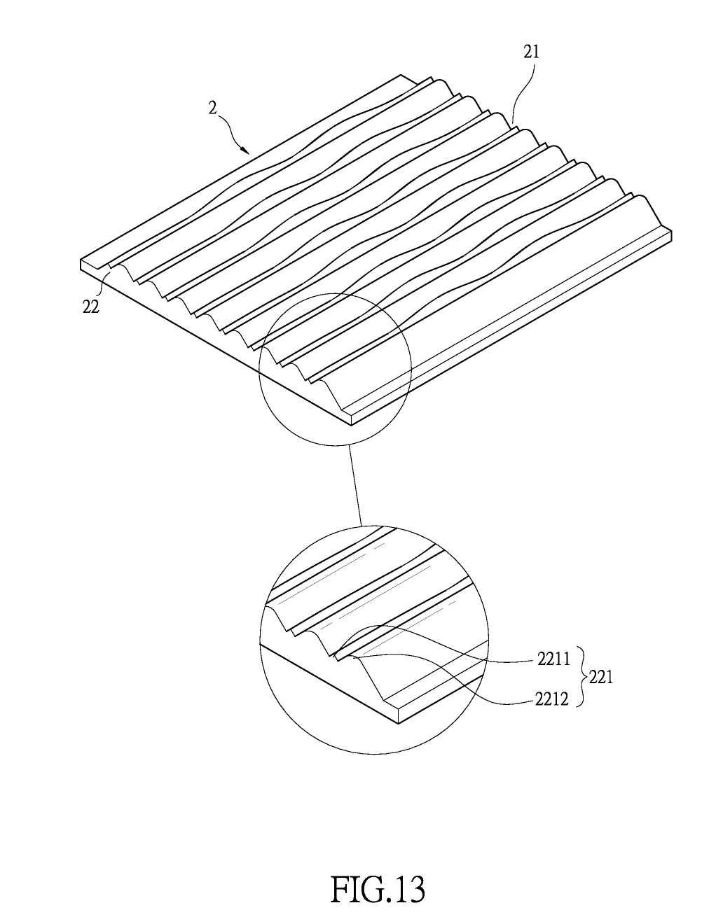

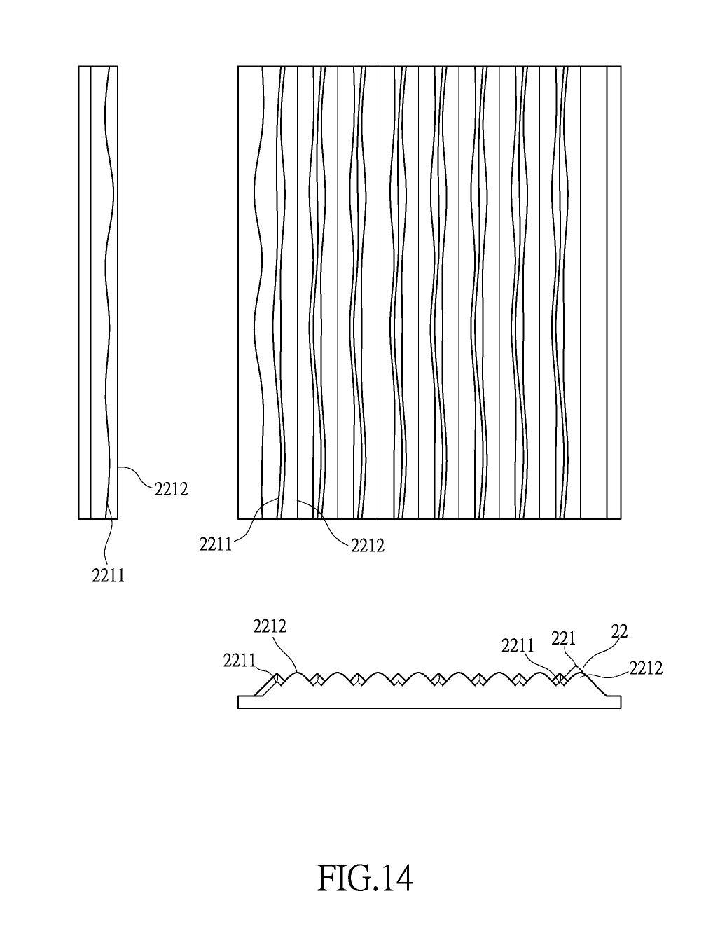

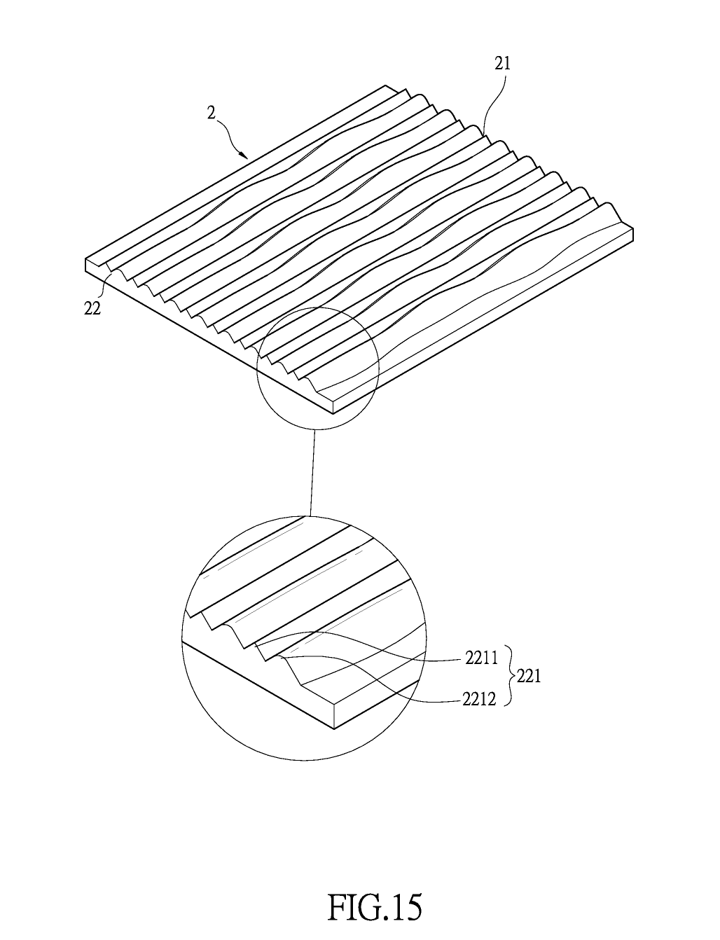

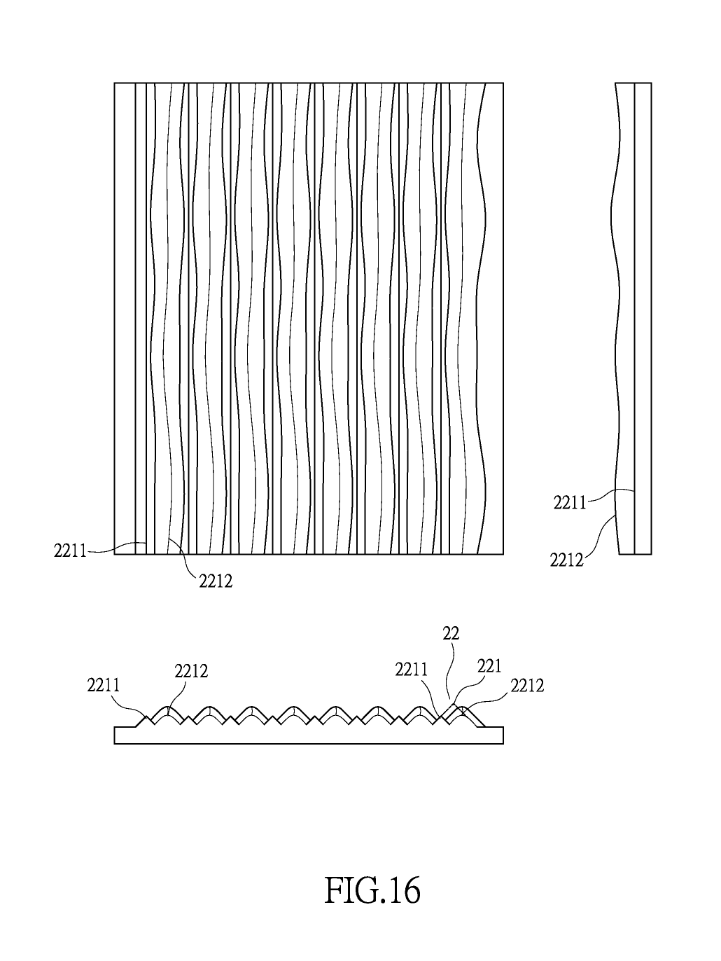

Referring to FIGS. 11-14, in practicing the present invention, the low ridge 2211 or the high ridge 2212 of the micro light guide 22 is made both a continuous left-and-right wavy configuration and a continuous up-and-down height-variation configuration, or alternatively as shown FIGS. 15 and 16, both the low ridge 2211 and the high ridge 2212 of the micro light guide 22 are made both a left-and-right wavy configuration and a continuous up-and-down height-variation configuration. As such, when light transmits through the optic film 2, the continuous up-and-down height-variation and continuous left-and-right wavy configuration of the low ridge 2211 (or the high ridge 2212) of the micro light guide 22 makes the light beam that is converged by the optic film 2 irregular so that the light induces no interference pattern in a liquid crystal display panel when the light passes through thin-film transistors and color filters of the liquid crystal display panel. The rounded configuration of the top of the high ridge 2212 helps protecting the top of the high ridge 2212 or the low ridge 2211 from damage caused by abrasion and/or wear when the optic films are stacked either after they have been assembled or when they are subjected to test, or helps protecting other parts from being damaged by the ridges, whereby the optic film 2 or the other parts can be properly protected and the optic performance thereof can be ensured.

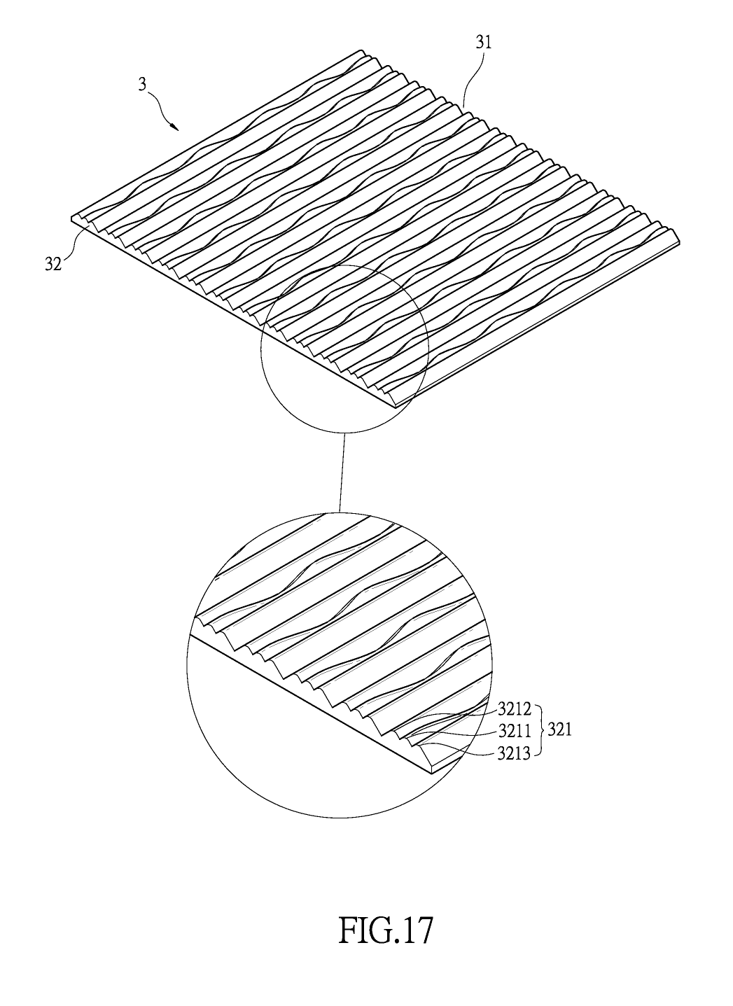

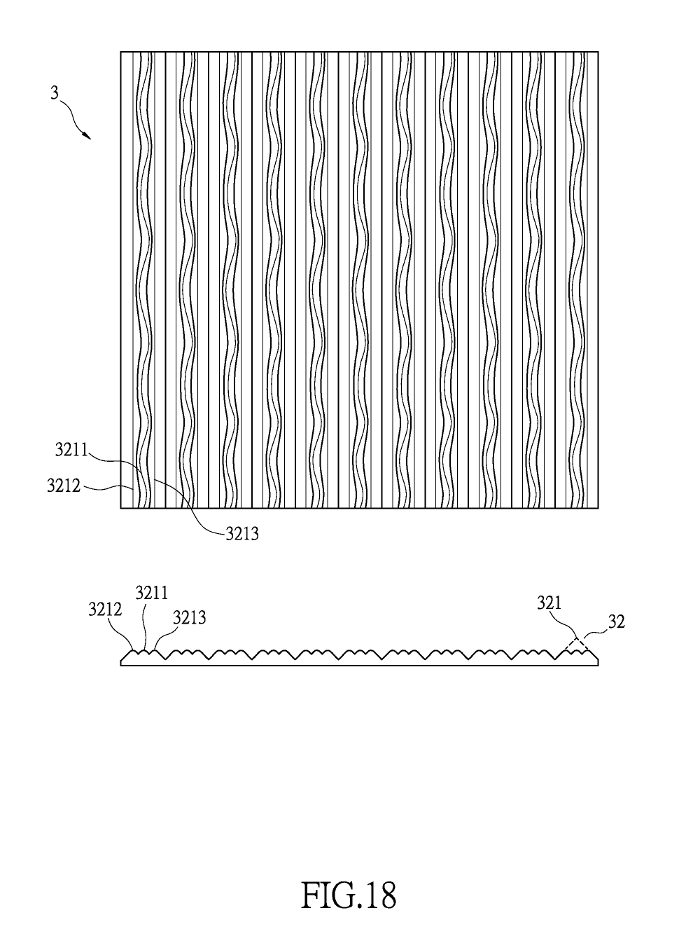

Referring to FIGS. 17 and 18, in practicing the present invention, alternatively, an optic film 3 has a surface 31 on which a plurality of rib-like micro light guides 32 is formed. Each micro light guide 32 comprises at least two ridges 321 and all the ridges 321 of the micro light guide 32 are of substantially identical height and all the ridges 321 or some of the ridges 321 have a varied or different configuration, wherein for example (the number of the ridges being taken as three for illustration purposes), a central ridge 3211 of the micro light guide 32 has a continuous left-and-right wavy configuration, while two side ridges 3212,3213 are of a straight linear configuration. The ridges 321 of the micro light guide are rounded. As such, when light transmits through the optic film 3, the continuous left-and-right wavy configuration of the central ridge 3211 of the micro light guide 32 makes the light beam passing therethrough irregular so that the light induces no interference pattern in a liquid crystal display panel when the light passes through thin-film transistors and color filters of the liquid crystal display panel. The rounded configuration of the top of the ridges 321 helps protecting the top of the ridges 321 from damage caused by abrasion and/or wear when the optic films are stacked either after they have been assembled or when they are subjected to test, or helps protecting other parts from being damaged by the ridges, whereby the optic film 3 or the other parts can be properly protected and the optic performance thereof can be ensured.

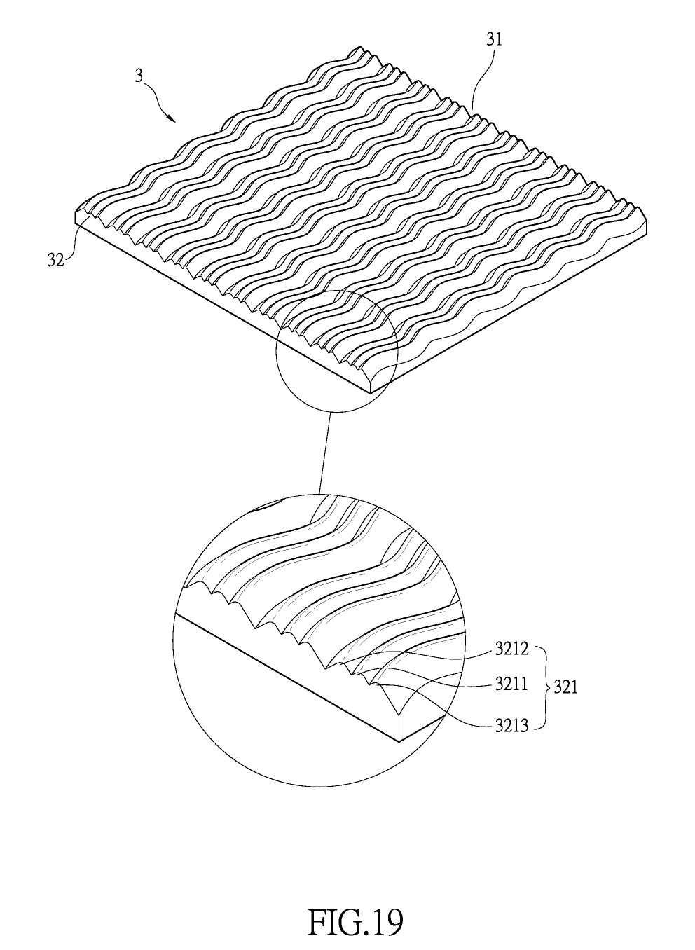

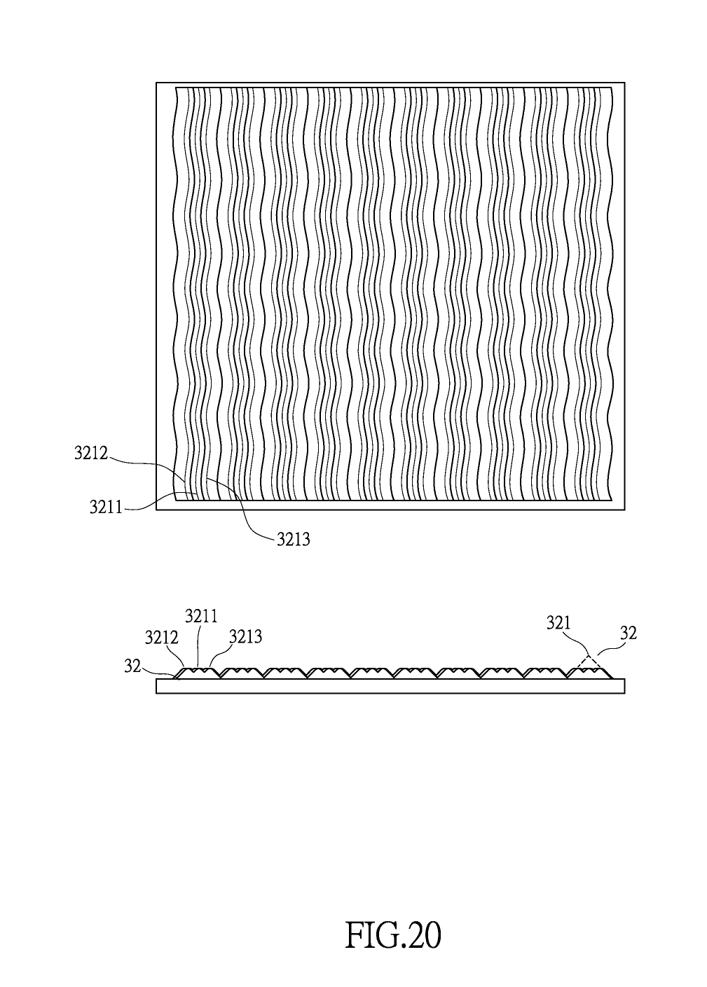

Referring to FIGS. 19 and 20, in practicing the present invention, alternatively, all the ridges 3211, 3212, 3213 of each micro light guide 32 of the optic film 3 are made a continuous left-and-right wavy configuration. As such, light transmitting through the optic film 3 can be of greater variation, so that the light induces no interference pattern in a liquid crystal display panel when the light passes through tin-film transistors and color filters of the liquid crystal display panel. The rounded configuration of the top of the ridges 321 helps protecting the top of the ridges 321 from damage caused by abrasion and/or wear when the optic films are stacked either after they have been assembled or when they are subjected to test, or helps protecting other parts from being damaged by the ridges, whereby the optic film 3 or the other parts can be properly protected and the optic performance thereof can be ensured.

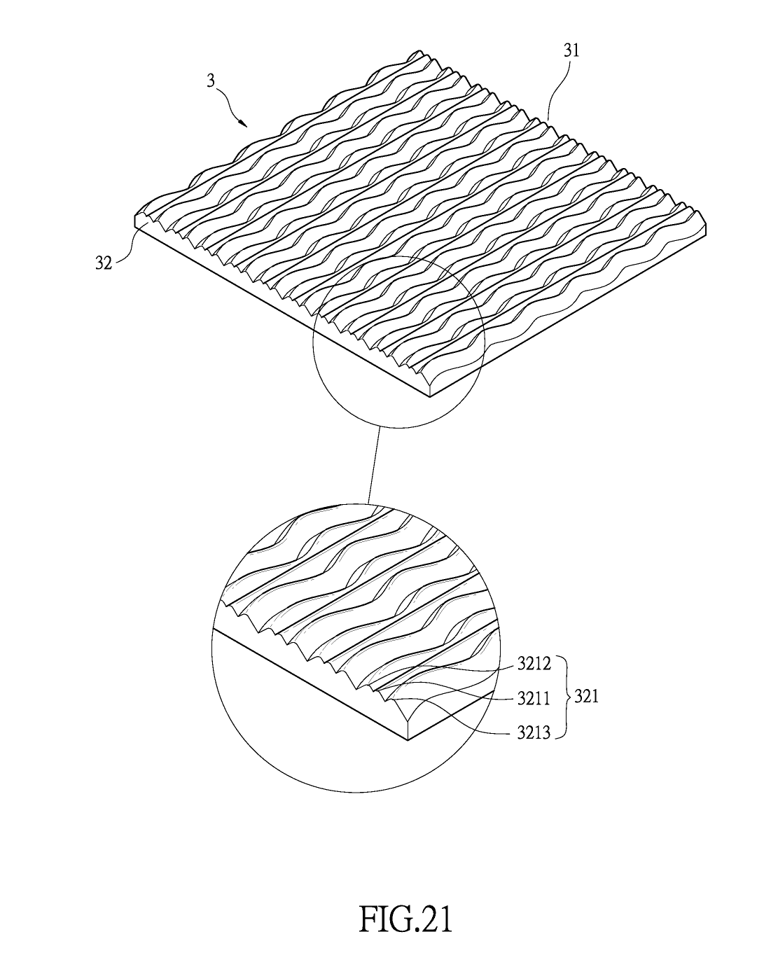

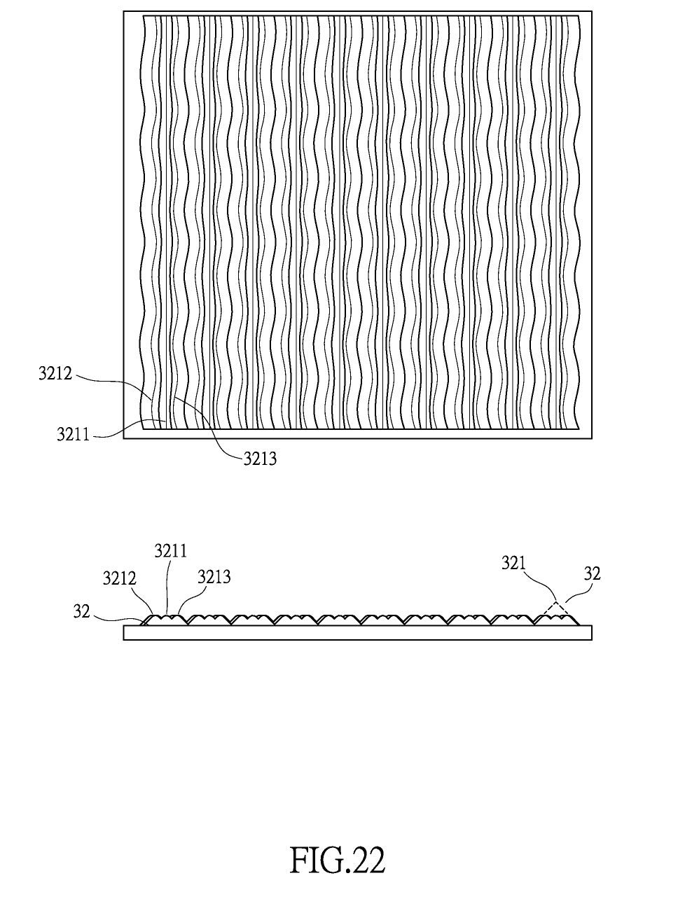

Referring to FIGS. 21 and 22, to embody the optic film 3 alternatively, two side ridges 3212, 3213 of each micro light guide 32, which are located on opposite sides of a central ridge 3211, are made a continuous left-and-right wavy configuration, while the central ridge 3211 is made a straight linear configuration. As such, light transmitting through the micro light guide 32 can be of variations, so that the light induces no interference pattern in a liquid crystal display panel when the light passes through thin-film transistors and color filters of the liquid crystal display panel. The rounded configuration of the top of the ridges 321 helps protecting the top of the ridges 321 from damage caused by abrasion and/or wear when the optic films are stacked either after they have been assembled or when they are subjected to test, or helps protecting other parts from being damaged by the ridges, whereby the optic film 3 or the other parts can be properly protected and the optic performance thereof can be ensured.

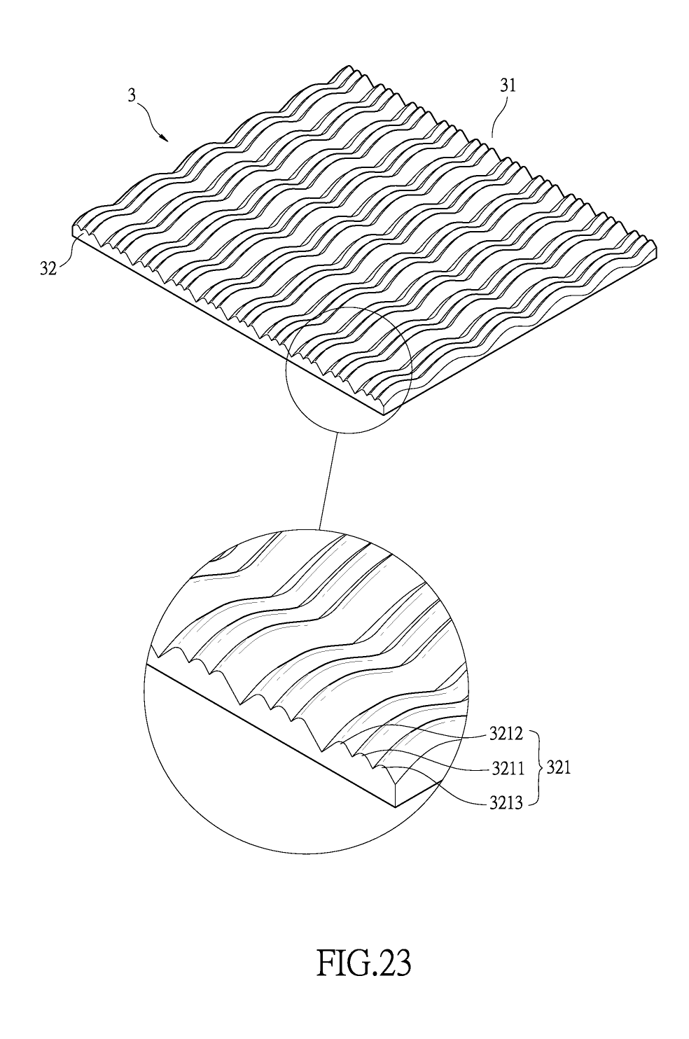

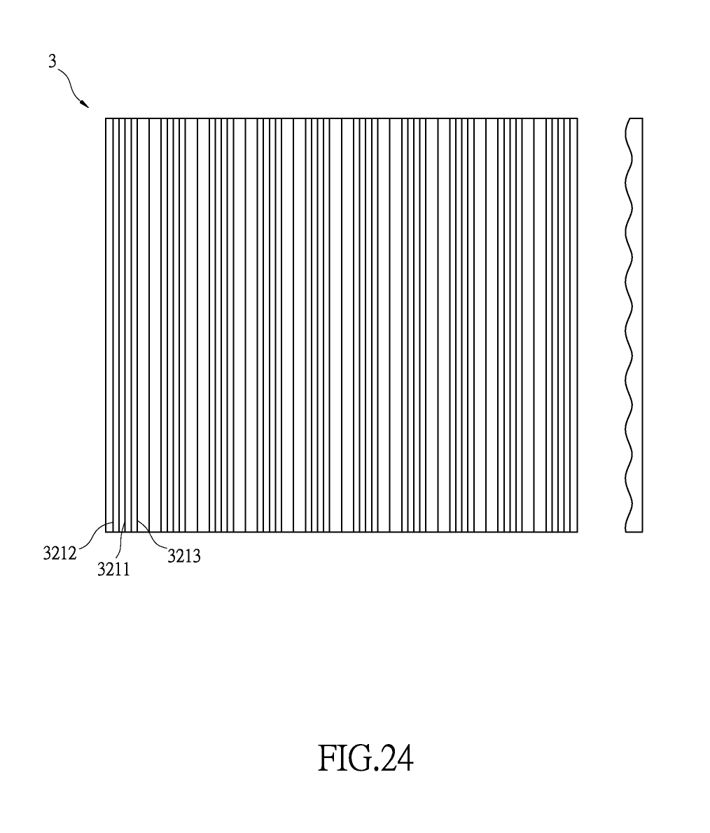

Referring to FIGS. 23 and 24, to embody the optic film 3 alternatively, the ridge 3211, 3212, 3213 of each micro light guide 32 are all made a continuous up-and-down height-variation configuration. As such, light transmitting through the optic film 3 can be of variations caused by the continuous up-and-down variation of heights of the ridges 3211, 3212, 3213 of the micro light guide 32, so that the light induces no interference pattern in a liquid crystal display panel when the light passes through thin-film transistors and color filters of the liquid crystal display panel. The rounded configuration of the top of the ridges 321 helps protecting the top of the ridges 321 from damage caused by abrasion and/or wear when the optic films are stacked either after they have been assembled or when they are subjected to test, or helps protecting other parts from being damaged by the ridges, whereby the optic film 3 or the other parts can be properly protected and the optic performance thereof can be ensured.

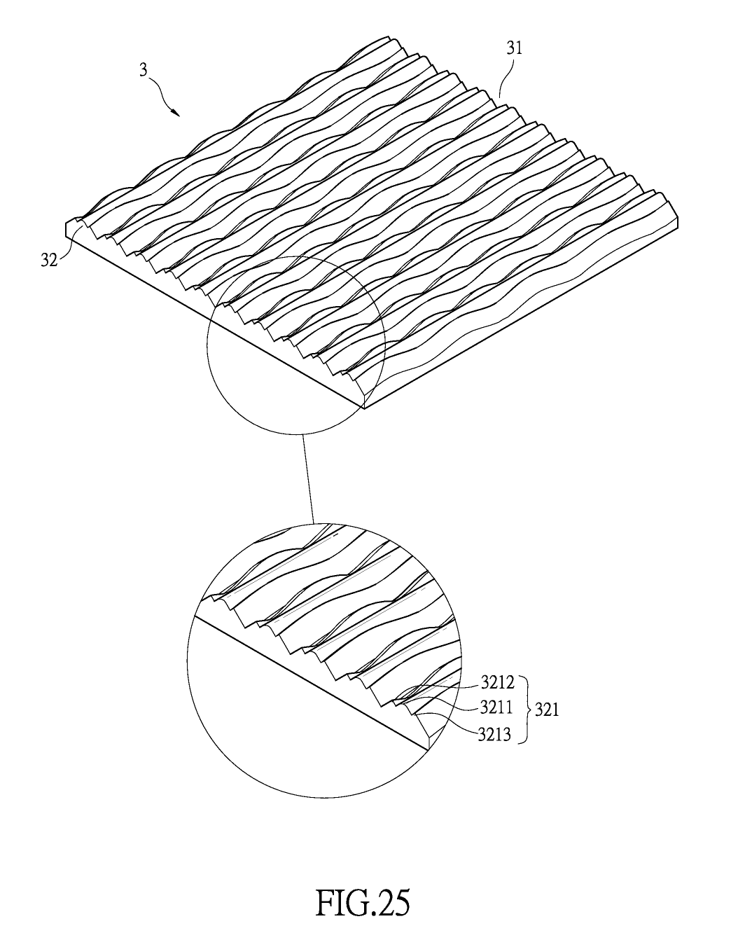

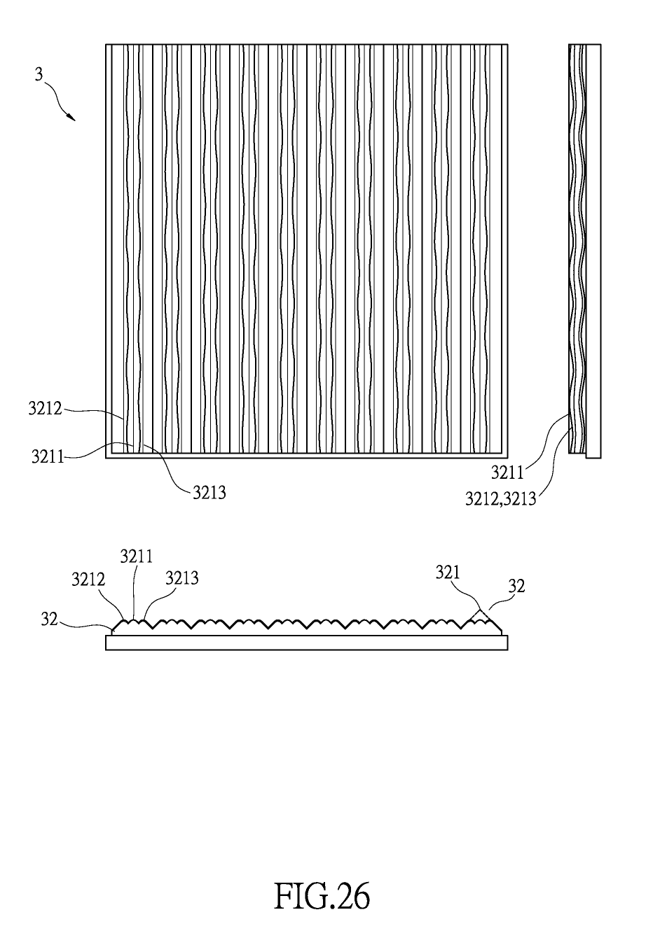

Referring to FIGS. 25 and 26, to embody the optic film 3 alternatively, two side ridges 3212, 3213 of each micro light guide 32, which are located on opposite sides of a central ridge 3211, are made a continuous up-and-down height-variation configuration, while the central ridge 3211 is of a fixed height. As such, light transmitting through the optic film 3 can be of variations caused by the continuous up-and-down variation of heights of the side ridges 3212, 3213 of the micro light guide 32, so that the light induces no interference pattern in a liquid crystal display panel when the light passes through thin-film transistors and color filters of the liquid crystal display panel. The rounded configuration of the top of the ridges 321 helps protecting the top of the ridges 321 from damage caused by abrasion and/or wear when the optic films are stacked either after they have been assembled or when they are subjected to test, or helps protecting other parts from being damaged by the ridges, whereby the optic film 3 or the other parts can be properly protected and the optic performance thereof can be ensured.

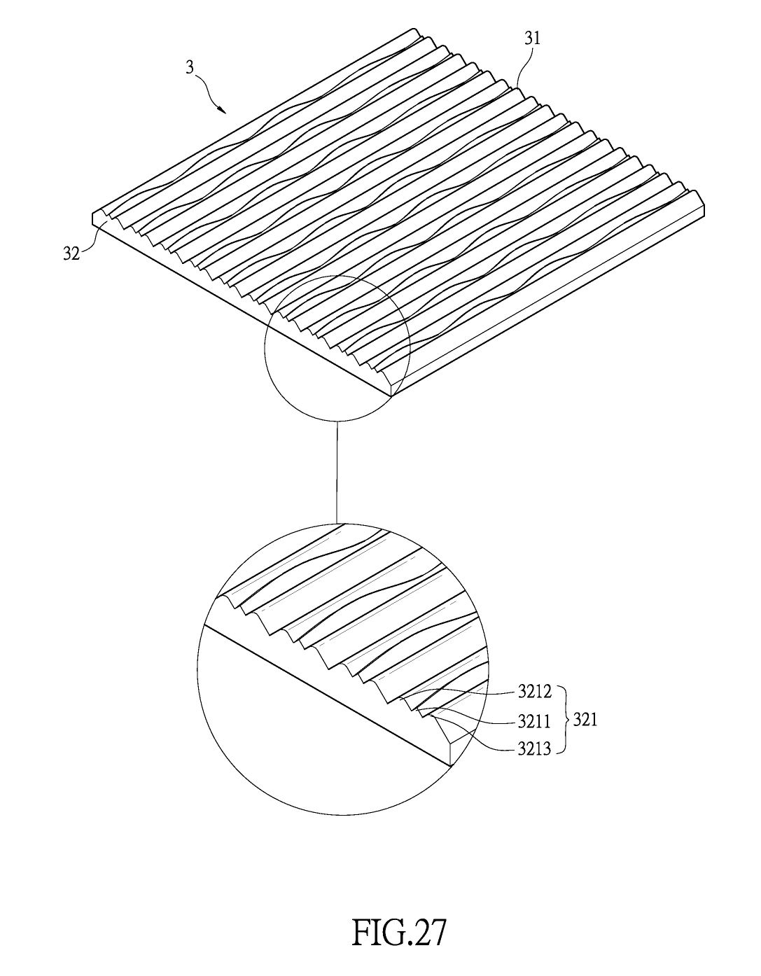

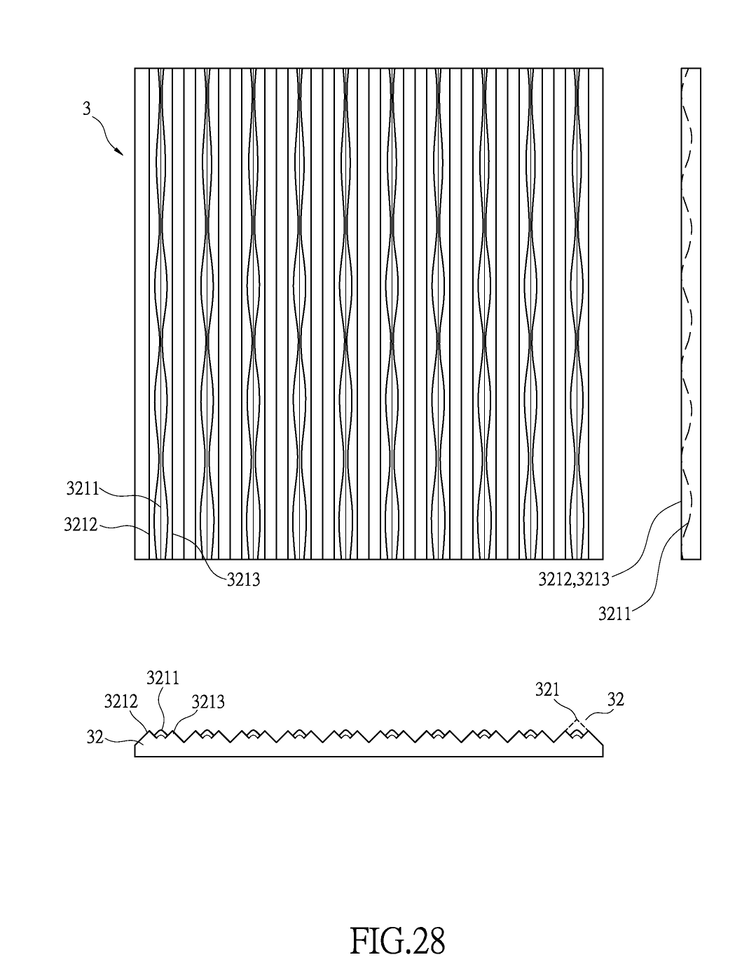

Referring to FIGS. 27 and 28, to embody the optic film 3 alternatively, a central ridge 3211 of each micro light guide 32 is made a continuous up-and-down height-variation configuration, while side ridges 3212, 3213, which are located on opposite sides of the central ridge 3211, are of fixed heights. As such, light transmitting through the micro light guide 32 can be of variations caused by the continuous up-and-down variation of height of the central ridges 3211 of the micro light guide 32, so that the light induces no interference pattern in a liquid crystal display panel when the light passes through thin-film transistors and color filters of the liquid crystal display panel. The rounded configuration of the top of the ridges 321 helps protecting the top of the ridges 321 from damage caused by abrasion and/or wear when the optic films are stacked either after they have been assembled or when they are subjected to test, or helps protecting other parts from being damaged by the ridges, whereby the optic film 3 or the other parts can be properly protected and the optic performance thereof can be ensured.

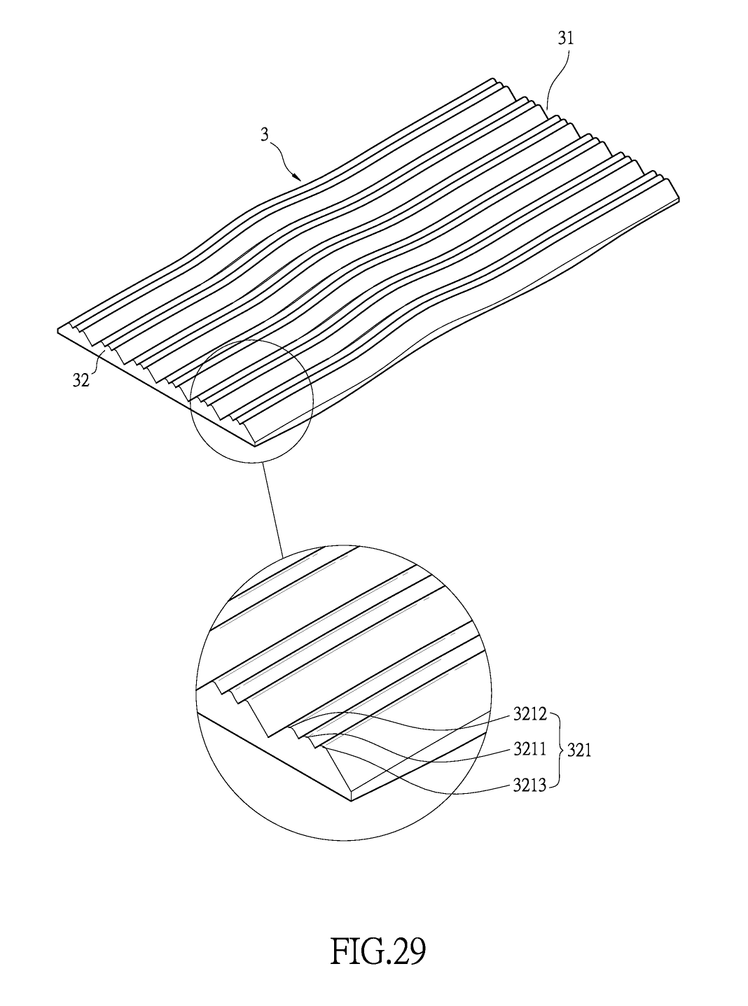

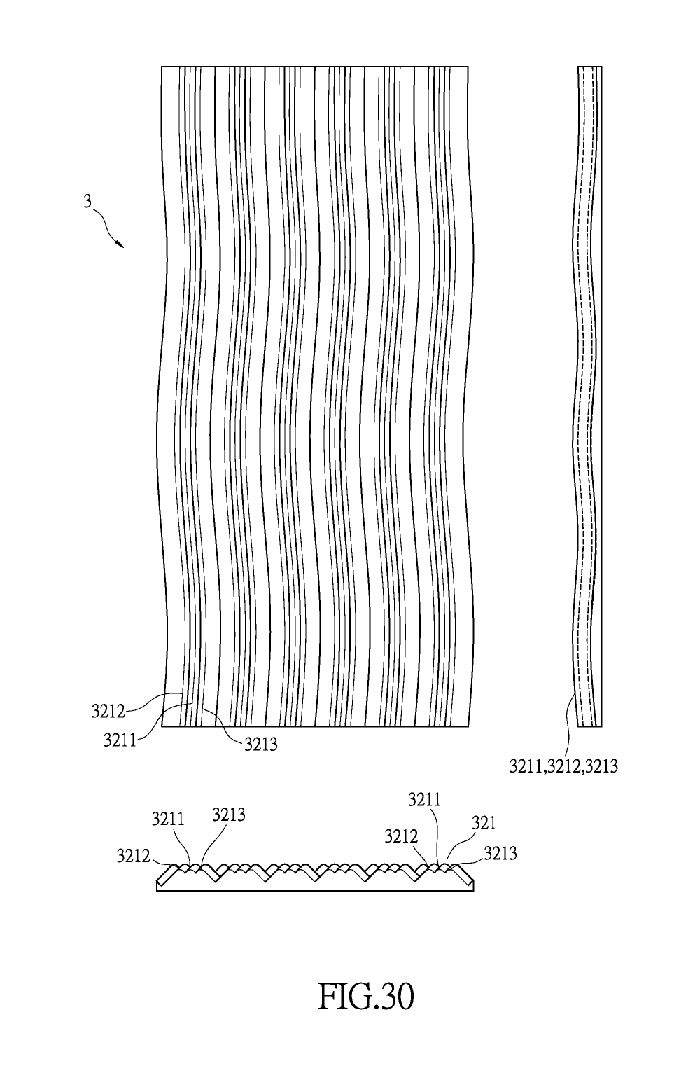

Referring to FIGS. 29 and 30, to embody the optic film 3 alternatively, ridges 3211, 3212, 3213 of each micro light guide 32 are all made both a continuous left-and-right wavy configuration and a continuous up-and-down height-variation configuration. As such, light transmitting through the micro light guide 32 can be of variations, so that the light induces no interference pattern in a liquid crystal display panel when the light passes through thin-film transistors and color filters of the liquid crystal display panel. The rounded configuration of the top of the ridges 321 helps protecting the top of the ridges 321 from damage caused by abrasion and/or wear when the optic films are stacked either after they have been assembled or when they are subjected to test, or helps protecting other parts from being damaged by the ridges, whereby the optic film 3 or the other parts can be properly protected and the optic performance thereof can be ensured.

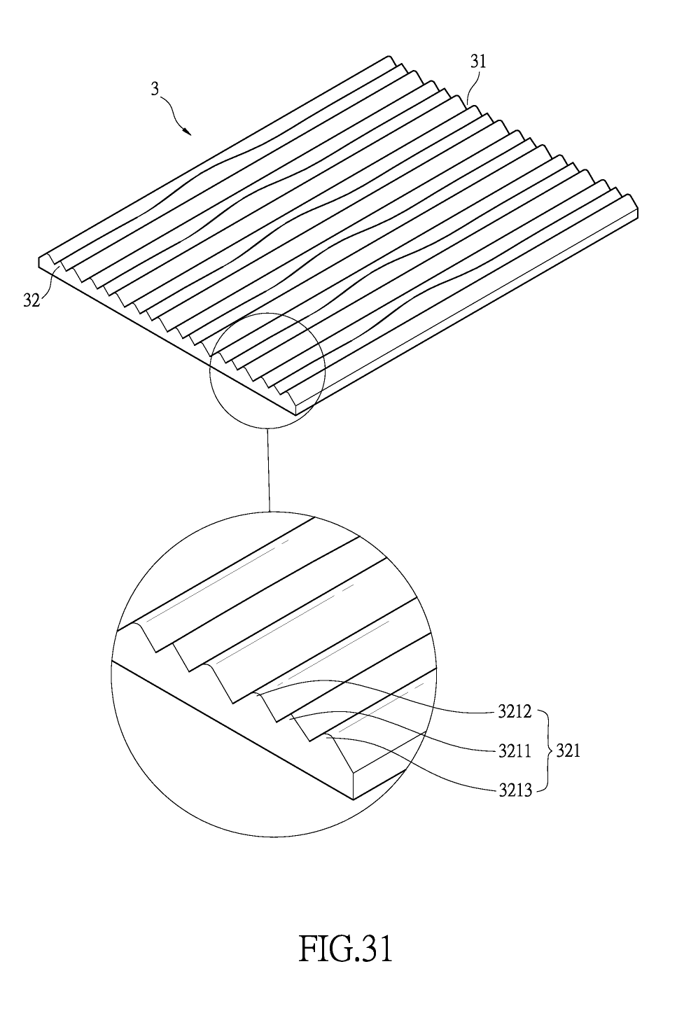

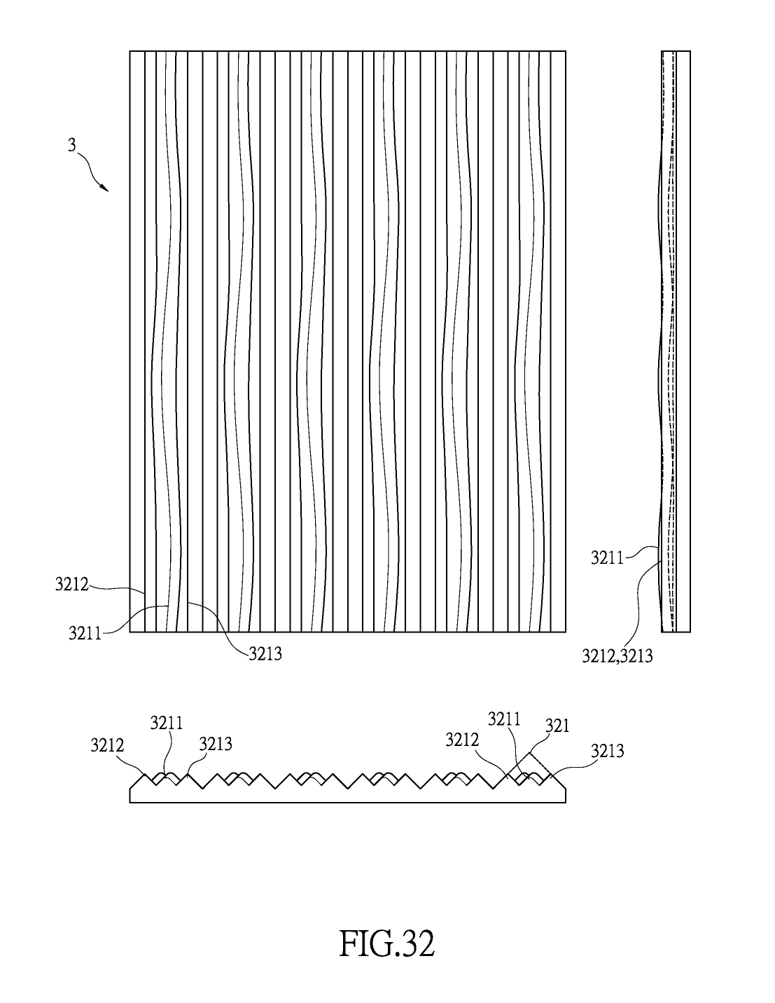

Referring to FIGS. 31 and 32, to embody the optic film 3 alternatively, a central ridge 3211 of the micro light guide 32 is made both a continuous left-and-right wavy configuration and a continuous up-and-down height-variation configuration, while side ridges 3212, 3213, which are located on opposite sides of the central ridge 3211, are made straight linear. As such, light transmitting through the micro light guide 32 can be of variations, so that the light induces no interference pattern in a liquid crystal display panel when the light passes through thin-film transistors and color filters of the liquid crystal display panel. The rounded configuration of the top of the ridges 321 helps protecting the top of the ridges 321 from damage caused by abrasion and/or wear when the optic films are stacked either after they have been assembled or when they are subjected to test, or helps protecting other parts from being damaged by the ridges, whereby the optic film 3 or the other parts can be properly protected and the optic performance thereof can be ensured.

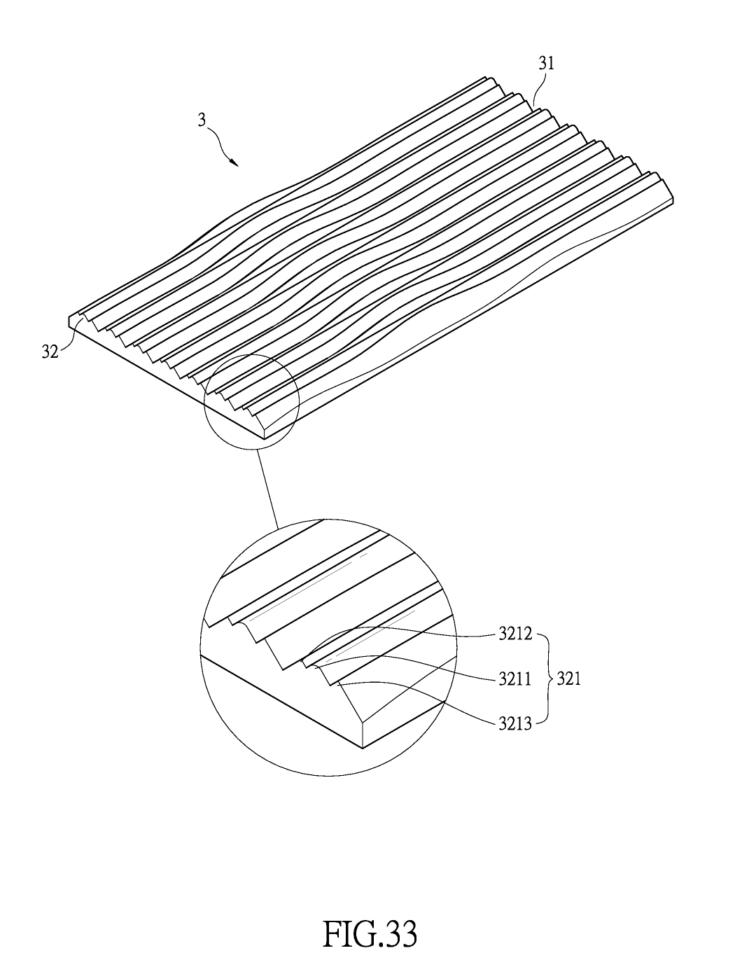

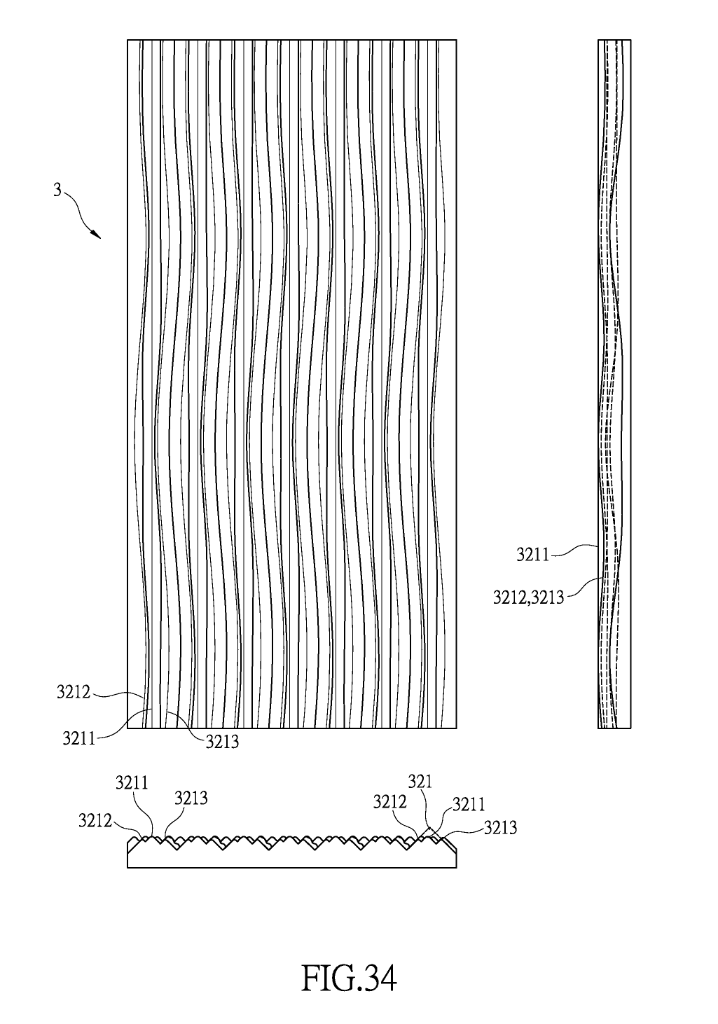

Referring to FIGS. 33 and 34, to embody the optic film 3 alternatively, a central ridge 3211 of the micro light guide 32 is made straight linear, while side ridges 3212, 3213, which are located on opposite sides of the central ridge 3211, are made both a continuous left-and-right wavy configuration and a continuous up-and-down height-variation configuration. As such, light transmitting through the micro light guide 32 can be of variations, so that the light induces no interference pattern in a liquid crystal display panel when the light passes through thin-film transistors and color filters of the liquid crystal display panel. The rounded configuration of the top of the ridges 321 helps protecting the top of the ridges 321 from damage caused by abrasion and/or wear when the optic films are stacked either after they have been assembled or when they are subjected to test, or helps protecting other parts from being damaged by the ridges, whereby the optic film 3 or the other parts can be properly protected and the optic performance thereof can be ensured.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An optic film having a surface forming a plurality of micro light guides, each comprising at least two ridges, which are selectively of different heights whereby the ridges comprise at least one low ridge and at least one high ridge, and characterized in that the high ridge has a top that is rounded.

2. The optic film as claimed in claim 1, wherein the micro light guides are made of a material that is identical to or different from a body of the optic film.

3. The optic film as claimed in claim 1, wherein the low ridge of the micro light guide is of a continue left-and-right wavy configuration.

4. The optic film as claimed in claim 1, wherein the high ridge of the micro light guide is of a continue left-and-right wavy configuration.

5. The optic film as claimed in claim 1, wherein the low ridge of the micro light guide is of a continuous up-and-down height-variation configuration.

6. The optic film as claimed in claim 1, wherein the high ridge of the micro light guide is of a continuous up-and-down height-variation configuration.

7. The optic film as claimed in claim 1, wherein the low ridge of the micro light guide is of both a continuous left-and-right wavy configuration and a continuous up-and-down height-variation configuration.

8. The optic film as claimed in claim 1, wherein the high ridge of the micro light guide is of both a continuous left-and-right wavy configuration and a continuous up-and-down height-variation configuration.

9. The optic film as claimed in claim 1, wherein both the low ridge and the high ridge of the micro light guide are of both a continuous left-and-right wavy configuration and a continuous up-and-down height-variation configuration.

10. The optic film as claimed in claim 1, wherein the low ridge of the micro light guide has a top that is rounded.

11. An optic film having a surface forming a plurality of micro light guides, each comprising at least two ridges, which are of identical height, and characterized in that the ridge has a top that is rounded.

12. The optic film as claimed in claim 11, wherein the micro light guides are made of a material that is identical to or different from a body of the optic film.

13. The optic film as claimed in claim 11, wherein a first number of the ridges of the micro light guide are of a continue left-and-right wavy configuration, while a second number of the ridges are of a straight linear configuration.

14. The optic film as claimed in claim 11, wherein each ridge of the micro light guide is of a continue left-and-right wavy configuration.

15. The optic film as claimed in claim 11, wherein each ridge of the micro light guide is of a continuous up-and-down height-variation configuration.

16. The optic film as claimed in claim 11, wherein a first number of the ridges of the micro light guide are of a continuous up-and-down height-variation configuration, while a second number of the ridges are of fixed heights.

17. The optic film as claimed in claim 11, wherein each ridge of the micro light guide is of both a continuous left-and-right wavy configuration and a continuous up-and-down height-variation configuration.

18. The optic film as claimed in claim 11, wherein a first number of the ridges of the micro light guide are of both a continuous left-and-right wavy configuration and a continuous up-and-down height-variation configuration, while a second number of the ridges are of a straight linear configuration.

19. The optic film as claimed in claim 11, wherein a first number of the ridges of the micro light guide are of a continuous left-and-right wavy configuration, while a second number of the ridges are of a continuous up-and-down height-variation configuration
